(19) United States
(12) Patent Application Publication
(10) Pub. No.: US 2016/0294124 A1
(43) Pub. Date: Oct. 6, 2016

(54) LIMITED EXPOSURE SWITCHED RECEPTACLE

(71) Applicants: Ryan P. MCILRATH, Rutland, MA (US); Brian M. MCILRATH, Danbury, CT (US)

(72) Inventors: Ryan P. MCILRATH, Rutland, MA (US); Brian M. MCILRATH, Danbury, CT (US)

(21) Appl. No.: 14/868,699

(22) Filed: Sep. 29, 2015

Related U.S. Application Data
(60) Provisional application No. 62/140,347, filed on Mar. 30, 2015.

(51) Int. Cl. H01R 13/703

(52) U.S. Cl. CPC H01R 13/703

(57) ABSTRACT

Exemplary embodiments of the present invention may be directed to a power receptacle that includes a clip configured to receive a hot prong of a load plug, a hot lead connector, and a switch configured to electrically connect the clip and the hot lead connector when the hot prong of the load plug has been inserted into the power receptacle. The switch may include a first spring blade in electrical contact with the clip, and a second spring blade in electrical contact with the hot lead connector. The switch may also include a slide mechanism operably connected to the first spring blade and configured to urge the first spring blade into electrical contact with the second spring blade when the hot prong of the load plug has been inserted into the power receptacle.

### CROSS-REFERENCE TO RELATED APPLICATIONS

This application claims priority to U.S. Provisional Appl. No. 62/140,347 filed Mar. 30, 2015, which is hereby incorporated by reference in its entirety.

### BACKGROUND OF THE INVENTION

1. Field of the Invention

The present invention is directed to limited exposure switched receptacles, and more particularly to an electric receptacle that energizes the hot terminal only when a load-plug is inserted close to or in the full-insertion position.

2. Description of Related Art

Existing 120 VAC electrical receptacles leave the hot terminal continuously energized, which can present a hazard, among other times, when a load-plug is only partially inserted. The partially inserted load-plug can leave five-sixteenth of an inch or more of the energized prong of the load-plug exposed outside of the electrical receptacle cover. Small fingers that reach beyond the shield of the load-plug are subject to electric shock, and foreign objects that fall across the hot and neutral prongs of the load-plug can result in a fire. Tamper-proof receptacles, intended for child safety, allow for exposed hot and neutral prongs of a load-plug, and suffer the same drawbacks. Therefore, what is needed is an electrical receptacle that can limit the potential external exposure of the prongs of the load-plug.

### SUMMARY OF THE INVENTION

The present invention is designed to overcome the above noted limitations that are attendant upon the use of conventional electrical receptacles and, toward this end, it contemplates the provision of a limited exposure switched receptacle.

Accordingly, it is an object of the present invention to provide an electrical receptacle in which electrical connectivity will not occur if a load-plug is not properly in place.

It is another object of the present invention to provide an electrical receptacle that provides a protective function against accidental shock during the insertion and removal of a load-plug.

It is yet another object of the present invention to provide an electrical receptacle that provides a protective function against accidental shock when a load-plug is not inserted a sufficient amount and/or fully inserted into the receptacle.

It is still another object of the present invention to provide an electrical receptacle that provides a protective function against electrical fires when a load-plug is not inserted a sufficient amount and/or fully inserted into the receptacle.

It is another object of the present invention to provide an electrical receptacle that does not have an energized hot terminal unless a load-plug is inserted a sufficient amount into the receptacle.

In accordance with exemplary embodiments of the present invention, the present invention may be directed to a power receptacle that includes a clip configured to receive a hot prong of a load plug, a hot lead connector configured to be electrically separated from the clip, and a switch configured to electrically connect the clip and the hot lead connector when the hot prong of the load plug has been inserted into the power receptacle.

In accordance with the exemplary embodiments of the present invention, the switch may include a first spring blade in electrical contact with the clip, and a second spring blade in electrical contact with the hot lead connector, and the first spring blade may be urged into electrical contact with the second spring blade when the hot prong of the load plug has been inserted into the power receptacle.

In accordance with the exemplary embodiments of the present invention, the switch may also include a slide mechanism operably connected to the first spring blade and configured to urge the first spring blade into electrical contact with the second spring blade when the hot prong of the load plug has been inserted into the power receptacle.

In accordance with the exemplary embodiments of the present invention, the switch may also include a first plated contact positioned on the first spring blade, and a second plated contact positioned on the second spring blade, where the first plated contact and the second plated contact are brought into electrical contact when the hot prong of the load plug has been inserted into the power receptacle.

In accordance with the exemplary embodiments of the present invention, the slide mechanism may be positioned between the clip and the first spring blade, and when the hot prong of the load plug is inserted into the power receptacle the hot prong first contacts the clip, then contacts the slide mechanism and causes the slide mechanism to cause electrical contact between the first spring blade and the second spring blade.

In accordance with the exemplary embodiments of the present invention, the switch may also include a latch operatively coupled to the slide mechanism and configured for contact with the hot prong of the load plug when the hot prong of the load plug is inserted into the power receptacle.

In accordance with the exemplary embodiments of the present invention, the slide mechanism may be positionable between an extended position in which the first spring blade is in electrical contact with the second spring blade and a retracted position in which the first spring blade is not in electrical contact with the second spring blade.

In accordance with the exemplary embodiments of the present invention, the slide mechanism may include a base, a vertical face positioned substantially perpendicular to the base, a curved face positioned on an opposite side of the slide mechanism from the vertical face and at least one step extending away from the base and positioned between the vertical face and the curved face.

In accordance with the exemplary embodiments of the present invention, the latch may include at least one latch finger configured to engage with the at least one step and retain the slide mechanism in a position to cause electrical contact between the first spring blade and the second spring blade.

In accordance with the exemplary embodiments of the present invention, the latch may also include a latch ridge configured for operative engagement with the hot prong of the load plug when the hot prong is inserted into the power receptacle so that the hot prong urges the latch in a manner that causes engagement of the at least one latch finger with the at least one step of the slide mechanism.

In accordance with the exemplary embodiments of the present invention, the latch may be made of a resilient spring material, and the latch may also include a latch ridge configured for operative engagement with the hot prong of the load plug when the hot prong is inserted into the power receptacle, and the resilient spring material of the latch is configured to urge at least one latch finger away from the at least one step when the hot prong of the load plug is not in contact with the latch ridge.

In accordance with the exemplary embodiments of the present invention, the slide mechanism is movable into the extended position when the hot prong of the load plug contacts the slide mechanism and causes movement of the slide mechanism in a direction away from the clip.

In accordance with the exemplary embodiments of the present invention, the hot lead connector is electrically separated from the clip when the hot prong of the load plug has not been inserted into the receptacle a sufficient distance to urge the first spring blade into electrical contact with the second spring blade.

In accordance with the exemplary embodiments of the present invention, at least the first spring blade is comprised of a resilient spring material, and the first spring blade is configured to urge the slide mechanism into the retracted position when the hot prong of the load plug has not been inserted into the receptacle.

In accordance with the exemplary embodiments of the present invention, the switch is a normally open switch, and the switch is closed when the hot prong of the load plug has been inserted a sufficient distance into the receptacle.

In accordance with other exemplary embodiments of the invention, the present invention may also be directed to a switch for a power receptacle that may include a first spring blade and a second spring blade configured for electrical contact when the switch is closed, a sliding mechanism configured for actuation by a hot prong of a load plug inserted into the power receptacle, and configured to urge the first spring blade into electrical contact with the second spring blade, and a latch configured to retain the first spring blade in electrical contact with the second spring blade when the hot prong of the load plug is inserted into the power receptacle.

In accordance with the other exemplary embodiments of the present invention, the switch may be a normally open switch, and the switch is closed when the hot prong of the load plug has been inserted a sufficient distance into the power receptacle.

In accordance with the other exemplary embodiments of the present invention, at least the first spring blade is comprised of a resilient spring material and configured to urge the first spring blade away from the second spring blade.

In accordance with the other exemplary embodiments of the present invention, the latch may be made of a resilient spring material and configured to release the first spring blade from electrical contact with the second spring blade when the hot prong of the load plug has been withdrawn from the power receptacle.

In accordance with the other exemplary embodiments of the present invention, the slide mechanism may be positionable between an extended position in which the first spring blade is in electrical contact with the second spring blade and a retracted position in which the first spring blade is not in electrical contact with the second spring blade.

### BRIEF DESCRIPTION OF THE DRAWINGS

For a fuller understanding of the nature and objects of the present invention, reference is made to the following detailed description taken in connection with the accompanying drawings in which:

FIG. 1A is a right side view of exemplary components of an embodiment of the limited exposure switched receptacle according to the present invention;

FIG. 1B is a right side view of the exemplary components of the limited exposure switched receptacle with a prong of a load plug inserted into the receptacle;

FIG. 1C is a right side view of a dual-receptacle assembly illustrating the function of select exemplary components of a limited exposure switched receptacle according to the present invention without a load plug inserted (upper receptacle) and with a load plug inserted (lower receptacle);

FIG. 2A is a bottom view of the exemplary components of the limited exposure switched receptacle according to the present invention (components or portions of components not illustrated are left out for purposes of visual clarity);

FIG. 2B is a bottom view of the exemplary components of the limited exposure switched receptacle with the prong of the load plug inserted into the receptacle (components or portions of components not illustrated are left out for purposes of visual clarity);

FIG. 2C is a bottom view of select exemplary components of the limited exposure switched receptacle as the load plug traverses through the full insertion and extraction sequence (components or portions of components not illustrated are left out for purposes of visual clarity);

FIG. 3A is a side view of an exemplary latch that may be used with the limited exposure switched receptacle according to the present invention;

FIG. 3B is a top plan view of the exemplary latch that may be used with the limited exposure switched receptacle according to the present invention;

FIG. 4A is a bottom plan view of an exemplary slide mechanism that may be used with the limited exposure switched receptacle according to the present invention;

FIG. 4B is a front view of the exemplary slide mechanism that may be used with the limited exposure switched receptacle according to the present invention;

FIG. 4C is a side view of the exemplary slide mechanism that may be used with the limited exposure switched receptacle according to the present invention; and

FIG. 4D is a rear view of the exemplary slide mechanism that may be used with the limited exposure switched receptacle according to the present invention.

### DETAILED DESCRIPTION

The present invention now will be described more fully hereinafter with reference to the accompanying figures, in which exemplary embodiments of the invention are shown. The invention may, however, be embodied in many different forms and should not be construed as limited to the embodiments set forth herein. Like reference numerals refer to like elements throughout.

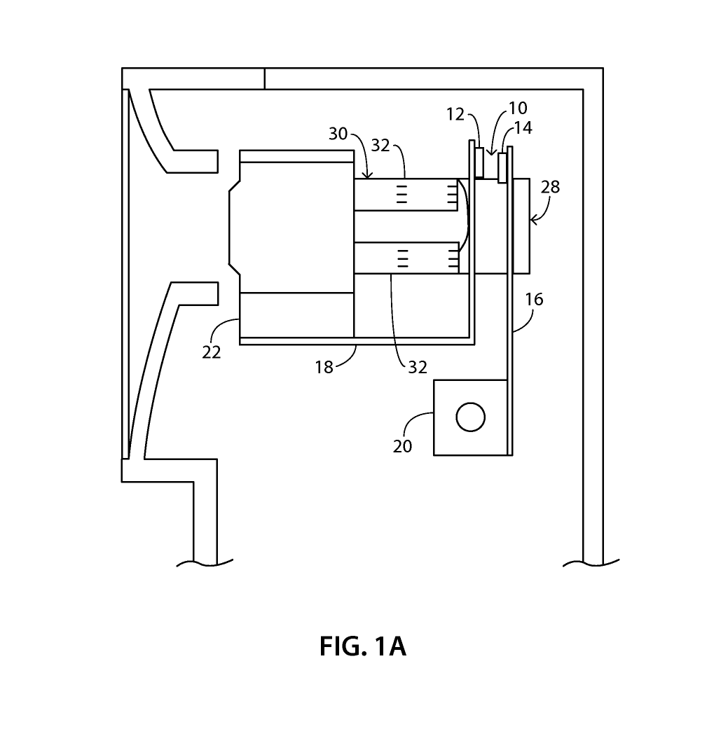

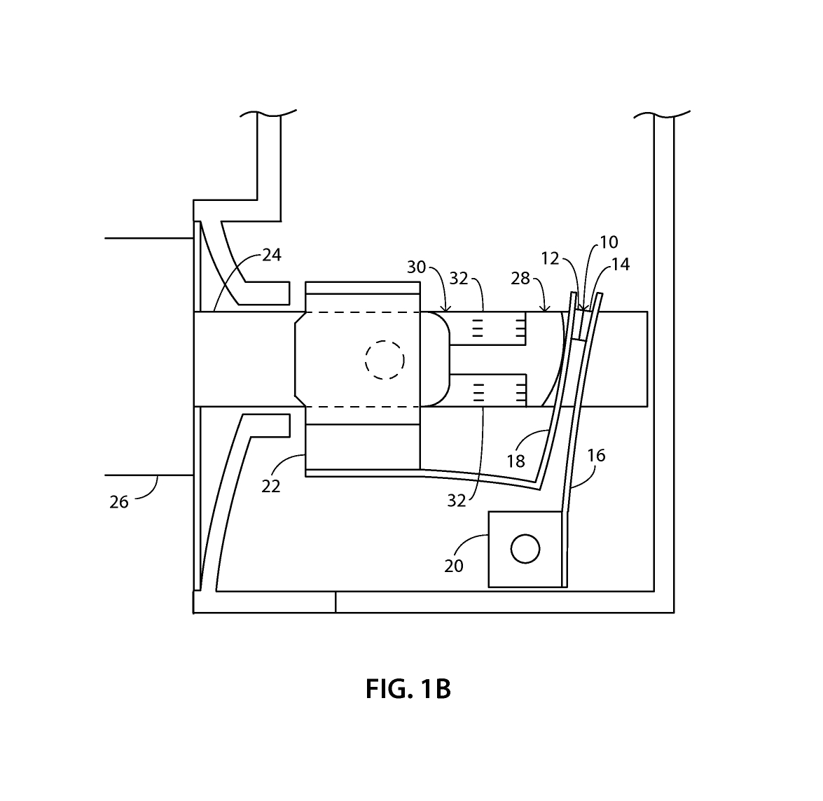

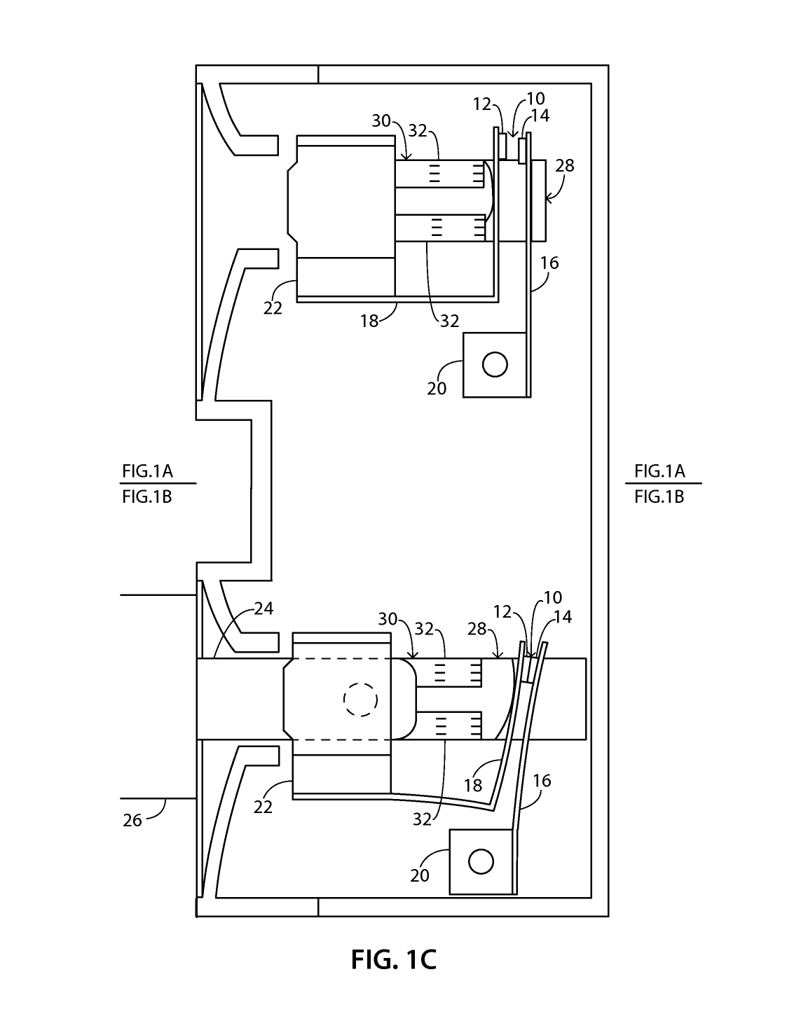

Referring now to FIGS. 1A-1C, therein illustrated are exemplary components of the limited exposure switched receptacle according to the present invention. It is understood that the other components of the limited exposure switched receptacle not illustrated, for example neutral and ground lead components, are standard components of a standard 120 VAC power receptacle, and are not illustrated because one of ordinary skill in the art would be familiar with their construction and orientation. In addition to or in place of the standard components of a 120 VAC power receptacle, exemplary embodiments of the limited exposure switched receptacle according to the present invention may include a switch, generally indicated by reference numeral 10, that is comprised of a pair of plated contacts 12, 14 mounted on spring blades 16, 18. One of the spring blades 16 is connected to a hot-lead terminal 20 of the receptacle, preferably the spring blade 16 is connected to the hot-lead terminal 20 so as to be electrically coupled with the hot-lead terminal 20. The other spring blade 18 is connected to a clip 22 positioned and configured so as to receive a hot prong 24 of a load-plug 26, and preferably the spring blade 18 is connected to the clip 22 so as to be electrically coupled with the clip 22. The limited exposure switched receptacle of the present invention may further include a slide mechanism 28, that may be formed from a plastic or other non-conductive material, and is positionable between a retracted position as shown in

FIG. 1A and an extended position as shown in FIG. 1B. The alternative positioning of the slide mechanism 28 will be discussed further below. As shown in FIG. 1A and the upper limited exposure switched receptacle of FIG. 1C, the load-plug 26 has not been inserted into the limited exposure switched receptacle, and therefore the slide mechanism 28 is in the retracted position. When the slide mechanism 28 is in the retracted position, the contacts 12, 14 are spaced apart and open, and the clip 22 is de-energized, as a result of being electrically de-coupled from the hot-lead terminal 20. In FIG. 1B and the lower limited exposure switched receptacle of FIG. 1C an exemplary load-plug 26 has been inserted therein, and such insertion a sufficient distance into the limited exposure switched receptacle causes the slide mechanism 28 to be depressed against the spring blade 18. The depression of the slide mechanism 28 against the spring blade 18 urges the spring blade 18 in a direction towards the other spring blade 16, thereby closing the contacts 12, 14 and energizing the clip 22 as a result of the clip 22 being electrically coupled to the hot-lead terminal 20. The switch 10 of the limited exposure switched receptacle is configured to be a normally open switch. The limited exposure switched receptacle may also include a latch 30 that may be comprised of spring-steel or other suitable resilient material. The latch 30 includes a pair of fingers 32 that straddle the slide mechanism 28.

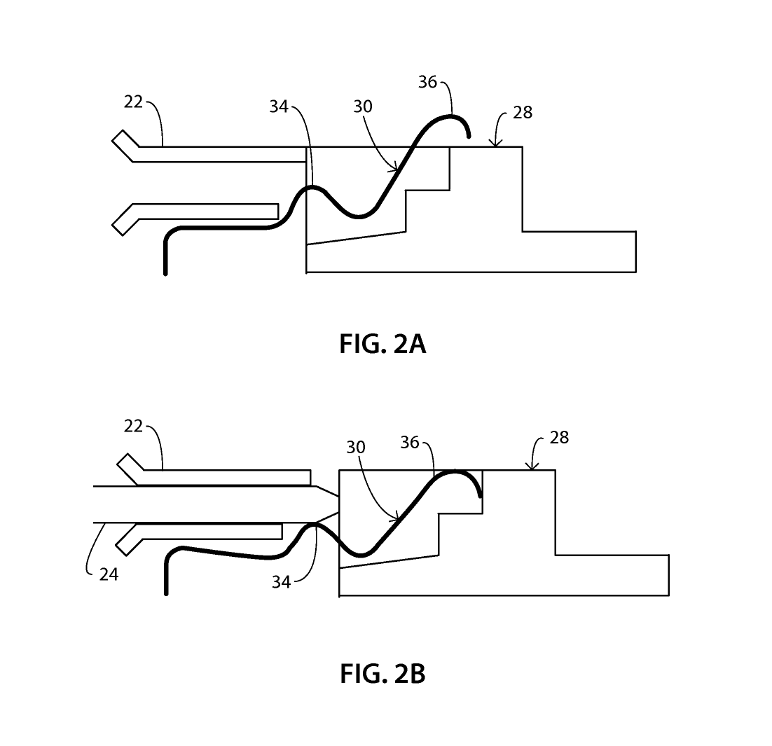

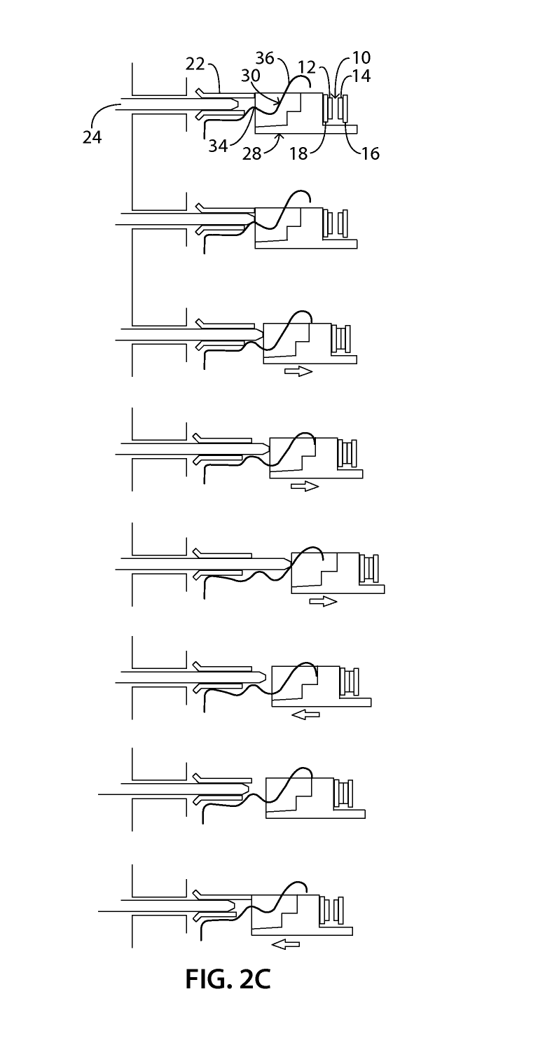

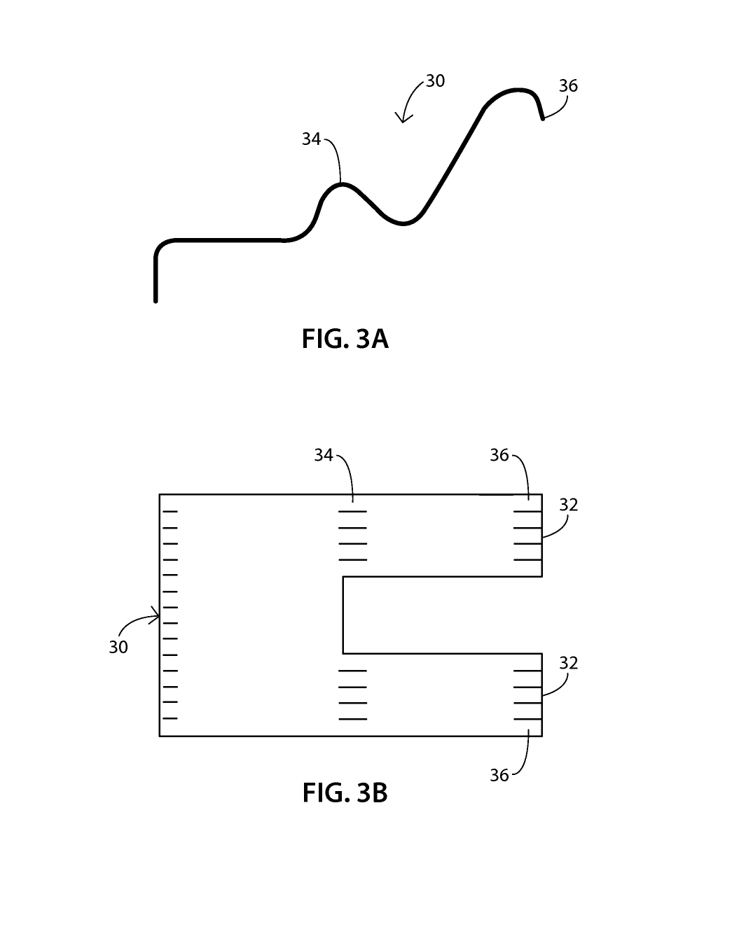

Referring now to FIGS. 2A, 2B, 3A and 3B, the latch 30 further includes a ridge 34 and a curved end 36 on each of the fingers 32 that operate to secure the slide mechanism 28 in its extended position (FIG. 2B) when the hot prong 24 of the load-plug 26 is sufficiently inserted into the limited exposure switched receptacle. For the purposes of this discussion, and without limiting the present invention thereto, the hot prong 24 of the load-plug 26 is considered sufficiently inserted into the limited exposure switched receptacle when the hot prong 24 urges the slide mechanism 28 a sufficient distance in order to cause the switch 10 to become closed. Preferably, this is an appropriate distance so that only a small or minor portion of the hot prong 24 is exposed from the limited exposure switched receptacle, but it is understood that the present invention is not limited to any particular distance that the hot prong 24 is exposed from the limited exposure switched receptacle.

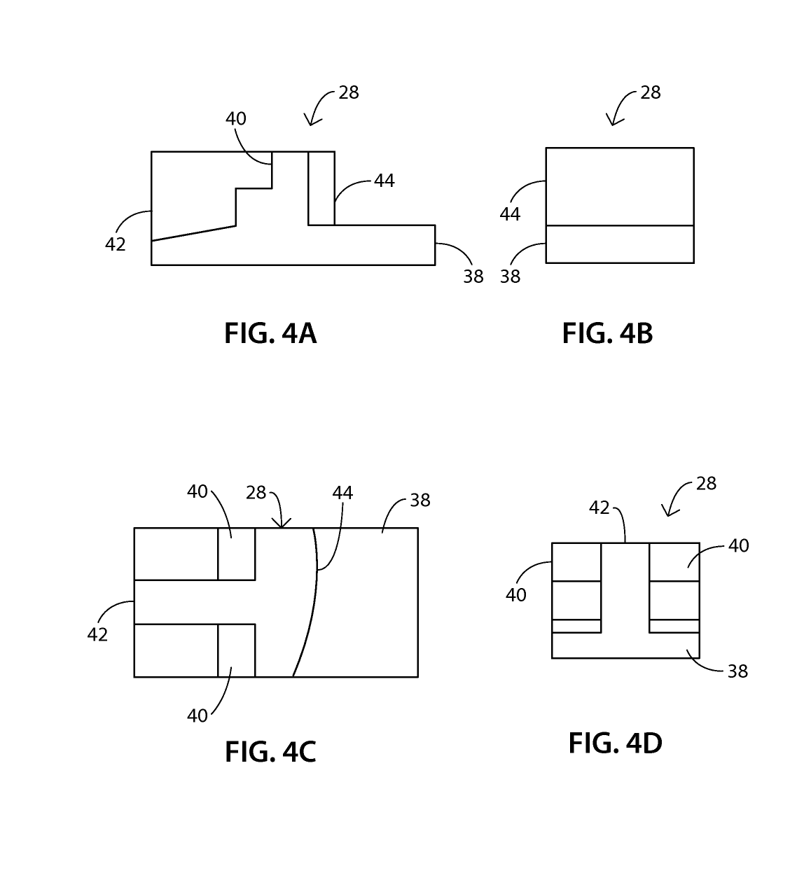

Referring now to FIGS. 4A-4D, the slide mechanism 28 may include a base 38, a vertical face 42 that allows for interaction with the hot prong 24, a curved face 44 that allows for interaction with spring blade 18 and a pair of slide steps 40 that allow for interaction with the latch 30.

Referring now to FIGS. 1A-1C, 2A-2C, 3A-3B and 4A-4D, the operation and use of the limited exposure switched receptacle will now be discussed. When the hot prong 24 of the load plug 26 is not inserted into the limited exposure switched receptacle the spring blade 18 presses against the slide mechanism 28 forcing it into the retracted position as shown in FIGS. 1A and 2A. In addition, as shown by FIG. 2C, when the hot prong 24 of the load plug 26 is only partially inserted into the limited exposure switched receptacle there is a gap between the contacts 12, 14 of the switch 10, because the switch 10 is a normally open switch. When the slide mechanism 28 is in the retracted position the plated contacts 12, 14 of the switch 10 are separated by a sufficient distance so as to not allow electrical current to flow between the plated contacts 12, 14.

Furthermore, when the slide mechanism 28 is in the retracted position the curved ends 36 of the fingers 32 rest just above the top surface of the slide mechanism 28, as shown for example in FIG. 2A. In the retracted position of the slide mechanism 28 no electricity can flow to the clip 22 for the hot prong 24 of the load-plug 26, because the circuit between the hot-lead terminal 20 and the clip 22 is incomplete as a result of the separation of the plated contacts 12, 14, and the clip 22 is electrically de-coupled from the hot-lead terminal 20. In this manner, even if a hot prong 24 is inserted into the receptacle, unless the hot prong 24 is inserted the sufficient distance into the limited exposure switched receptacle the hot prong 24 of the load-plug 26 will not be energized, and therefore if the hot prong 24 has been inserted into the limited exposure switched receptacle such that an appreciable portion of the hot prong 24 is exposed from the limited exposure switched receptacle accidental and/or inadvertent contact with the hot prong 24 will not result in a shock and/or fire hazard.

When the hot prong 24 of the load-plug 26 is inserted into the limited exposure switched receptacle, as shown in FIGS. 1B, 2B and certain views of FIG. 2C, the hot prong 24 contacts the vertical face 42 of the slide mechanism 28 and the ridge 34 of the latch 30. As the hot prong 24 is inserted further into the limited exposure switched receptacle, the hot prong 24 simultaneously pushes against the slide mechanism 28 and depresses the latch 30 as a result of contact with the ridge 34 of the latch 30. When the hot prong 24 has been inserted to a sufficient distance within the limited exposure switched receptacle, the hot prong 24 causes the slide mechanism 28 to be moved into its extended position, which also results in the fingers 32 of the latch 30 being urged into the slide steps 40 thereby locking the slide mechanism 28 into its extended position. The movement of the slide mechanism 28 into its extended position urges the spring blade 18 towards the other spring blade 16, resulting in the plated contacts 12, 14 of the switch 10 coming into electrically conductive contact with each other and closing the switch 10. With the plated contacts 12, 14 in electrically conductive contact, the clip 22 is thereby energized, which results in energizing of the hot prong 24 of the load-plug 26.

If the load-plug 26 is withdrawn from the receptacle, for example by more than an eighth of an inch, the ridges 34 of the latch 30 clears the forward-end of the hot prong 24, and the latch 30 returns to the raised position with the fingers 32 clearing the slide steps 40. The slide mechanism 28 is then urged towards the clip 22 by the spring blade 18 resulting in the separation of the plated contacts 12, 14 and opening of the switch 10. The opening of the switch 10 thereby de-energizes the clip 22 and hot prong 24. Base 38 of the slide mechanism 28 may sit in a recessed track that holds slide mechanism 28 in proper alignment as it moves between the retracted and extended positions. The base 38 of the slide mechanism 28 is further held into this recessed track by the presence of spring blades 16, 18.

It is understood that while the clip 22 configured to receive the hot prong 24 is energized or de-energized by the operation of the present invention, this action does not prevent the receptacle of the present invention from conducting current to other receptacles or switches that may be connected to it. For example, the receptacle of the present invention may be constructed such that only the clip 22 configured to receive the hot prong 24 may be energized and de-energized. It is further understood that while the term “hot prong 24” is used, it is understood that the receptacle according to the present invention may be constructed such that any prong of a load-plug may be inserted into the receptacle in order to cause operation of the receptacle in accordance with the present invention.

It will thus be seen that the objects set forth above, among those made apparent from the preceding description, are efficiently attained and, since certain changes may be made in the above article without departing from the scope of this invention, it is intended that all matter contained in this disclosure or shown in the accompanying drawings, shall be interpreted, as illustrative and not in a limiting sense. It is to be understood that all of the present figures, and the accompanying narrative discussions of corresponding embodiments, do not purport to be completely rigorous treatments of the invention under consideration. It is to be understood that the above-described arrangements are only illustrative of the application of the principles of the present invention. Numerous modifications and alternative arrangements may be devised by those skilled in the art without departing from the scope of the present invention.

What is claimed is:

1. A power receptacle, comprising:
a clip configured to receive a hot prong of a load plug;
a hot lead connector configured to be electrically separated from the clip; and
a switch configured to electrically connect the clip and the hot lead connector when the hot prong of the load plug has been inserted into the power receptacle.

2. The power receptacle according to claim 1, wherein the switch comprises a first spring blade in electrical contact with the clip, and a second spring blade in electrical contact with the hot lead connector, and wherein the first spring blade is urged into electrical contact with the second spring blade when the hot prong of the load plug has been inserted into the power receptacle.

3. The power receptacle according to claim 2, wherein the switch further comprises a slide mechanism operably connected to the first spring blade and configured to urge the first spring blade into electrical contact with the second spring blade when the hot prong of the load plug has been inserted into the power receptacle.

4. The power receptacle according to claim 2, wherein the switch further comprises a first plated contact positioned on the first spring blade, and a second plated contact positioned on the second spring blade, wherein the first plated contact and the second plated contact are brought into electrical contact when the hot prong of the load plug has been inserted into the power receptacle.

5. The power receptacle according to claim 3, wherein the slide mechanism is positioned between the clip and the first spring blade, and wherein when the hot prong of the load plug is inserted into the power receptacle the hot prong first contacts the clip, then contacts the slide mechanism and causes the slide mechanism to cause electrical contact between the first spring blade and the second spring blade.

6. The power receptacle according to claim 3, wherein the switch further comprises a latch operatively coupled to the slide mechanism and configured for contact with the hot prong of the load plug when the hot prong of the load plug is inserted into the power receptacle.

7. The power receptacle according to claim 5, wherein the slide mechanism is positionable between an extended position in which the first spring blade is in electrical contact with the second spring blade and a retracted position in which the first spring blade is not in electrical contact with the second spring blade.

8. The power receptacle according to claim 6, wherein the slide mechanism comprises a base, a vertical face positioned substantially perpendicular to the base, a curved face positioned on an opposite side of the slide mechanism from the vertical face and at least one step extending away from the base and positioned between the vertical face and the curved face.

9. The power receptacle according to claim 8, wherein the latch comprising at least one latch finger configured to engage with the at least one step and retain the slide mechanism in a position to cause electrical contact between the first spring blade and the second spring blade.

10. The power receptacle according to claim 9, wherein the latch further comprises a latch ridge configured for operative engagement with the hot prong of the load plug when the hot prong is inserted into the power receptacle so that the hot prong urges the latch in a manner that causes engagement of the at least one latch finger with the at least one step of the slide mechanism.

11. The power receptacle according to claim 9, wherein the latch is comprised of a resilient spring material, and the latch further comprises a latch ridge configured for operative engagement with the hot prong of the load plug when the hot prong is inserted into the power receptacle, and wherein the resilient spring material of the latch is configured to urge the at least one latch finger away from the at least one step when the hot prong of the load plug is not in contact with the latch ridge.

12. The power receptacle according to claim 7, wherein the slide mechanism is movable into the extended position when the hot prong of the load plug contacts the slide mechanism and causes movement of the slide mechanism in a direction away from the clip.

13. The power receptacle according to claim 2, wherein the hot lead connector is electrically separated from the clip when the hot prong of the load plug has not been inserted into the receptacle a sufficient distance to urge the first spring blade into electrical contact with the second spring blade.

14. The power receptacle according to claim 7, wherein at least the first spring blade is comprised of a resilient spring material, and wherein the first spring blade is configured to urge the slide mechanism into the retracted position when the hot prong of the load plug has not been inserted into the receptacle.

15. The power receptacle according to claim 1, wherein the switch is a normally open switch, and the switch is closed when the hot prong of the load plug has been inserted a sufficient distance into the receptacle.

16. A switch for a power receptacle, comprising:
a first spring blade and a second spring blade configured for electrical contact when the switch is closed;
a sliding mechanism configured for actuation by a hot prong of a load plug inserted into the power receptacle, and configured to urge the first spring blade into electrical contact with the second spring blade; and
a latch configured to retain the first spring blade in electrical contact with the second spring blade when the hot prong of the load plug is inserted into the power receptacle.

17. The switch according to claim 16, wherein the switch is a normally open switch, and the switch is closed when the hot prong of the load plug has been inserted a sufficient distance into the power receptacle.

18. The switch according to claim 16, wherein at least the first spring blade is comprised of a resilient spring material and configured to urge the first spring blade away from the second spring blade.

19. The switch according to claim 16, wherein the latch is comprised of a resilient spring material and configured to release the first spring blade from electrical contact with the second spring blade when the hot prong of the load plug has been withdrawn from the power receptacle.

20. The switch according to claim 16, wherein the slide mechanism is positionable between an extended position in which the first spring blade is in electrical contact with the second spring blade and a retracted position in which the first spring blade is not in electrical contact with the second spring blade.
